(19) United States
(12) Patent Application Publication
(10) Pub. No.: US 2010/0230240 A1
(43) Pub. Date: Sep. 16, 2010

(54) CONVEYING DEVICE

(76) Inventors: Gerard Cornelis Van Der Knijff, Emmeloord (NL); Arie Van Der Knijff, Emmeloord (NL); Bastiaan Pompstra, Emmeloord (NL)

Correspondence Address: LADAS & PARRY LLP, 26 WEST 61ST STREET, NEW YORK, NY, 10023, US

(21) Appl. No.: 12/438,433

(22) PCT Filed: Aug. 22, 2007
(86) PCT No.: PCT/NL07/00192

§ 371 Date: Mar. 29, 2010

(30) Foreign Application Priority Data
Aug. 23, 2006 (NL) 1032357

(51) Int. Cl. B65G 47/90

(52) U.S. Cl. 198/470.1

(57) ABSTRACT

Device and method for conveying an object having wall having an outer surface, wherein a device according to any one of the preceding claims is used, wherein at least one clamping set having at least one clamp, in an opened position thereof, is pressed against the outer surface and subsequently thereto the clamp is brought into a closed position while clamping the cloth material of the wall, and the clamping set is moved to a location of discharge, where the clamp is opened again.

### BACKGROUND OF THE INVENTION

The invention relates to a conveying device. The invention particularly relates to a device and method for conveying objects having a surface that is deformable out of the plane or provided with parts of material protruding therefrom.

It may in particular regard bags, having a wall that is at least partially made of paper material or foil material or of cloth, such a textile, fabric, non-woven, knitted ware, etcetera. The wall can at least be pleated locally. In case of cloth, cloth material in the form of protruding fibres, threads, having ends or in pronounced or flat loop shape or any other way protrudes from the surrounding surface of the cloth. An example thereof is a jute bag.

Bags, particularly bags of paper material or foil material, are known to be engaged for their conveyance by means of suction cups arranged on a carriage or something similar. Such arrangements may be complex.

In case of bags of cloth the surfaces of said objects, particularly bags, usually are air permeable, as a result of which engagement using suction cups may be difficult, particularly when the air permeability is strong. The suction force should be adjusted thereto.

Alternatively the bags can be clasped at the upper edge of a wall, using a clamping hook at the inside and a clamping hook at the outside, yet the bag also needs to be opened for that purpose and moreover room at the location of the bag opening will be necessary. Mechanisms for this purpose may be complex.

It is an object of the invention to provide a device and a method with which such objects, particularly bags, can be engaged and conveyed more easily and reliably.

### SUMMARY OF THE INVENTION

According to one aspect the invention provides a device for conveying objects having a deformable outer surface, particularly a bag, comprising at least one clamping set having at least one clamp, and means for pressing the clamp in an opened position thereof against the surface and means for subsequently thereto bringing the clamp from the opened position to a closed position in which at least a part of said surface is clamped.

With the device according to the invention engaging an outer surface of the object, particularly a bag, will suffice. Due to exerting pressure during closing the clamp, the wall material will be able to extend within the clamp and be clamped therein. During closing the clamp a local pleat is formed as it were, which pleat is clamped.

According to another aspect the invention provides a device for conveying objects having a surface made of cloth provided with parts of material that protrude therefrom, for instance a bag having a wall that is at least partially made of textile, comprising at least one clamping set having at least one clamp, and means for pressing the clamp in an opened position thereof against the surface and means for subsequently thereto bringing the clamp from the opened position to a closed position in which at least a part of said surface of the cloth is clamped.

With the device according to the invention engaging an outer surface of the object, particularly a bag, will suffice. A reliable transportation of the object does not depend on the air permeability of the wall in question. The movement of the clamping set can be kept simple: clasping or something like that will not be necessary.

In both cases wall material extending out of the plane is clamped, which wall material may or may not be present beforehand (for instance protruding fibres vs. pleat made by closing of the clamps).

In one embodiment the clamping set comprises several clamps, as a result of which the forces, particularly conveying forces, can be distributed over several locations.

In a further embodiment thereof at least two clamps of the clamping set are situated adjacent to each other and have one clamping jaw in common. In this way the structure can remain simple.

In a further embodiment thereof three or more clamps of the clamping set are situated adjacent to each other and each time have one clamping jaw in common.

The clamping engagement is further enhanced when the means for bringing the clamps to the closed position substantially simultaneously act on the clamps of a clamping set.

In one embodiment the common clamping jaw moves when closing the clamps. In an alternative or additional embodiment (when more than two clamps are present), a common clamping jaw can be stationary when closing the clamps.

In a simple embodiment the means for bringing the clamps to the closed position comprise a common cylinder set.

The means for bringing the clamps to the closed position can be adapted for rotating at least one of the clamping jaws in question. Preferably the rotatable clamping jaws have spaced apart axes of rotation. In that way an arrangement having several clamps becomes simple.

In a further development of the device according to the invention it is provided with means for moving the clamping set between a receiving position in which the clamps clamp the surface of the object and a discharge position in which the clamps release the object.

In a further development of the device according to the invention it comprises several clamping sets, wherein the movement means are adapted for substantially simultaneous movement of the clamping sets. In that way the engagement forces can be further distributed.

According to a further aspect the invention provides a method for conveying an object having a wall having an outer surface, wherein a device according to the invention is used, wherein at least one clamping set having at least one clamp, in the opened position thereof, is pressed against the outer surface and subsequently thereto the clamp is brought into a closed position while clamping material of the wall, and the clamping set is moved to a location of discharge, where the clamp is opened again.

The wall can at least partially be made of deformable material, wherein the material during closing the clamp forms a pleat therein which is clamped.

The wall may at least partially be made of cloth material, which at the outer surface is provided with parts of material that protrude, such as fibres, threads and the like, which parts of material are clamped. The material of the cloth surface can be jute. The object can be a bag that can be picked up from a stock and conveyed to a filling station, by means of a device according to the invention.

The aspects and measures described in this description and the claims of the application and/or shown in the drawings of this application may where possible also be used individually. Said individual aspects may be the subject of divisional patent applications relating thereto. This particularly applies to the measures and aspects described per se in the sub claims.

### SHORT DESCRIPTION OF THE DRAWINGS

The invention will be elucidated on the basis of a number of exemplary embodiments shown in the attached drawings, in which:

FIGS. 1A and 1B show an exemplary embodiment of a clamping set for a device according to the invention, in an inclined bottom view and an inclined top view, respectively;

FIG. 2 shows a top view of the clamping set of FIGS. 1A and 1B;

FIG. 3 shows a partial cross-section of the clamping set of FIG. 2;

FIGS. 4A and 4B show the clamping set of the previous figures, in a condition immediately before engaging a wall of a bag to be conveyed and a condition during engagement, respectively; and

FIGS. 5A and 5B show conditions corresponding with FIGS. 4A and 4B during engaging the wall of another type of bag.

### DETAILED DESCRIPTION OF THE DRAWINGS

The clamping set 1 according to the attached figures has a main body or main block 1, forming one unity with body 14, which in turn forms one unity with an attachment plate 12 that is transverse thereto and provided with fixing holes 13. By means of the fixing holes 13 and fasteners to be passed therethrough, the clamping set 1 can be attached to a reciprocally movable carriage or something similar of a conveying device.

At the main body 2 a number of clamping plates 3, 4a, 4b, 5a, 5b are attached. The clamping plate 3 is immovably attached to the main body 2. The clamping plates 4a, 4b are rotatably attached to the main body 2 by means of hinge pins 9a, 9b. The clamping plates 5a, 5b are rotatably attached to the main body 2 by means of hinge pins 10a. 10b.

The clamping plates 3, 4a,b and 5a,b are provided with clamping ends 6, 7a,b and 8a,b, respectively.

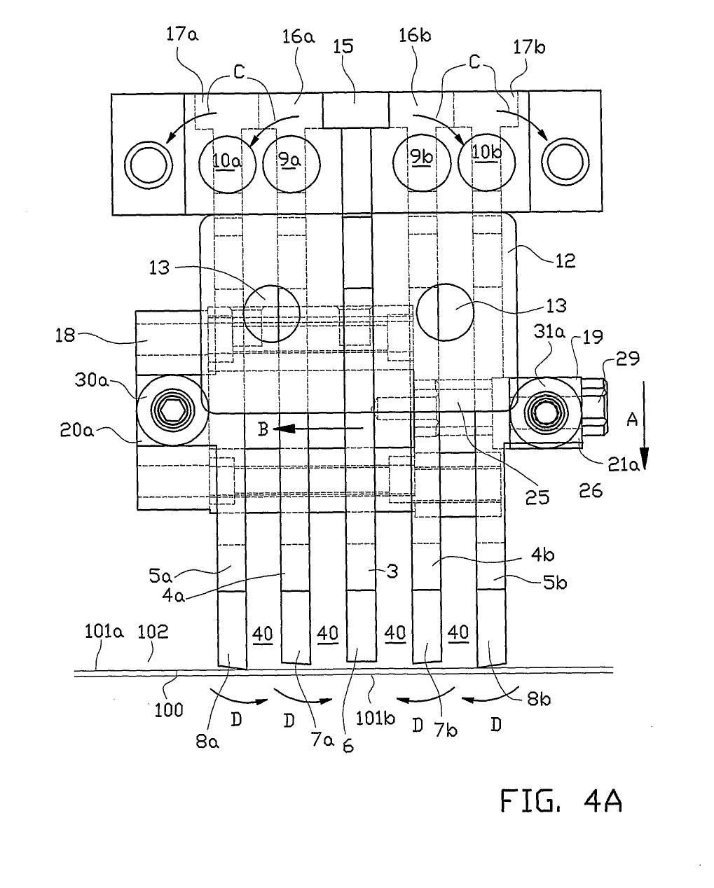

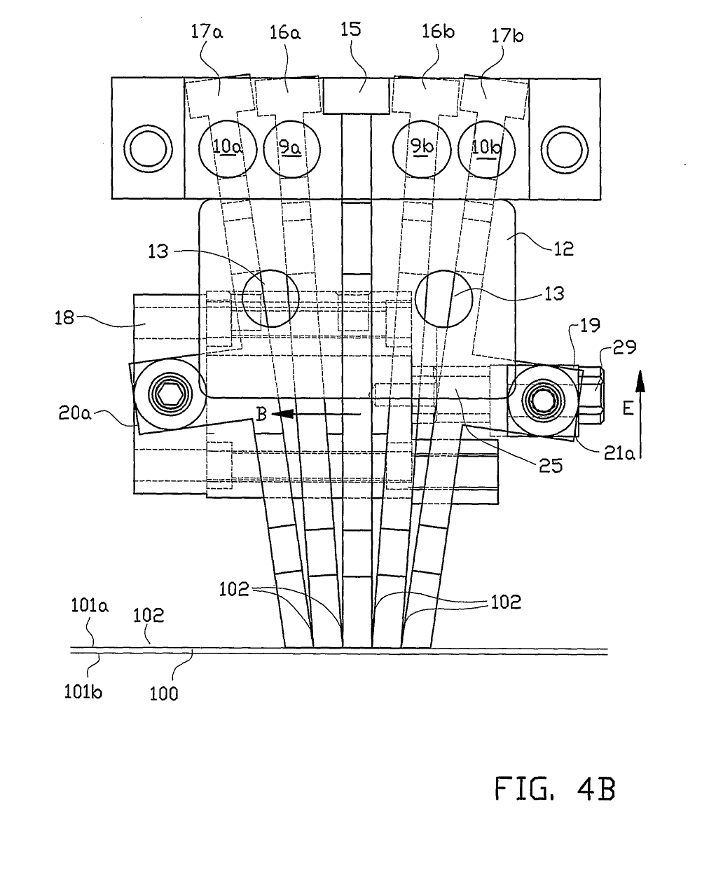

The clamping plates 4a, 4b are continued beyond the hinge pins 9a, 9b and end in T-shaped heads 16a, 16b. The hinge plates 5a, 5b are continued beyond the hinge pins 10a, 10b and end in T-shaped heads 17a, 17b. In the open position of the clamping plates (FIG. 4A) the heads 16a,b, 17a,b and a strip 15 placed above the clamping plate abut with their sides.

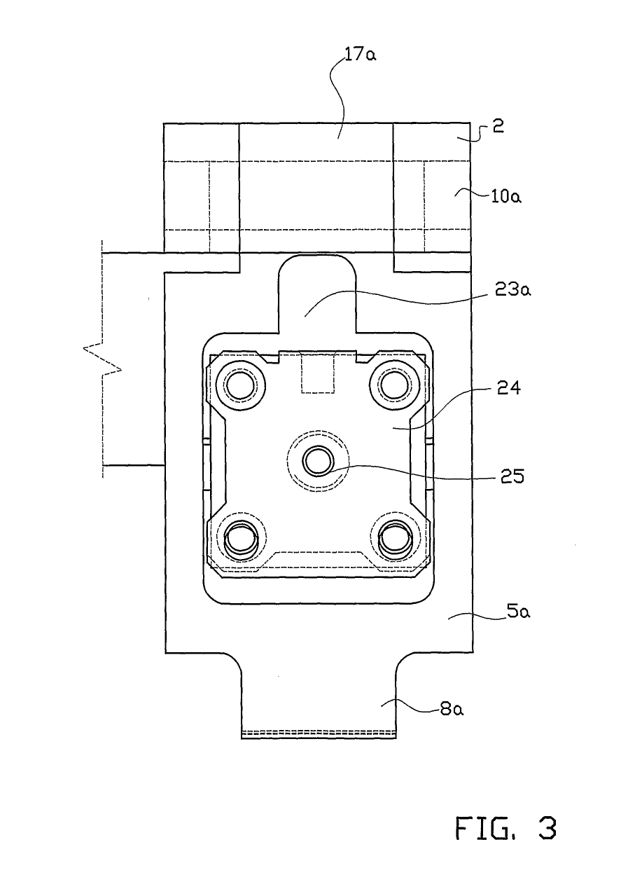

The clamping plates 3, 4a,b and 5a,b, as can also be seen in FIG. 3, are each provided with a hole 23 (clamping plate 5a with hole 23a is shown), through which an operation cylinder, for instance pneumatic, extends with play and which has cylinder casing 24 and piston rod 25. The cylinder casing 24 is fixedly attached to plate 18, which by means of bolts 30a, 30b is attached to ears 20a,b formed as one rigid unity with the clamping plate 5b. With its end the piston rod 25 is accommodated in recess 26 of a block 19, and thereto by means of bolt 29. The block 19 itself is attached by means of bolts 31a,b to lips 21a,b formed as one rigid unity with the clamping plate 5a. In that way when retracting the piston rod 25 the mutual distance between the clamping plates 5a,b will be reduced. When expanding the cylinder 24, piston rod 25 the clamping plates 5a,b will be moved apart again.

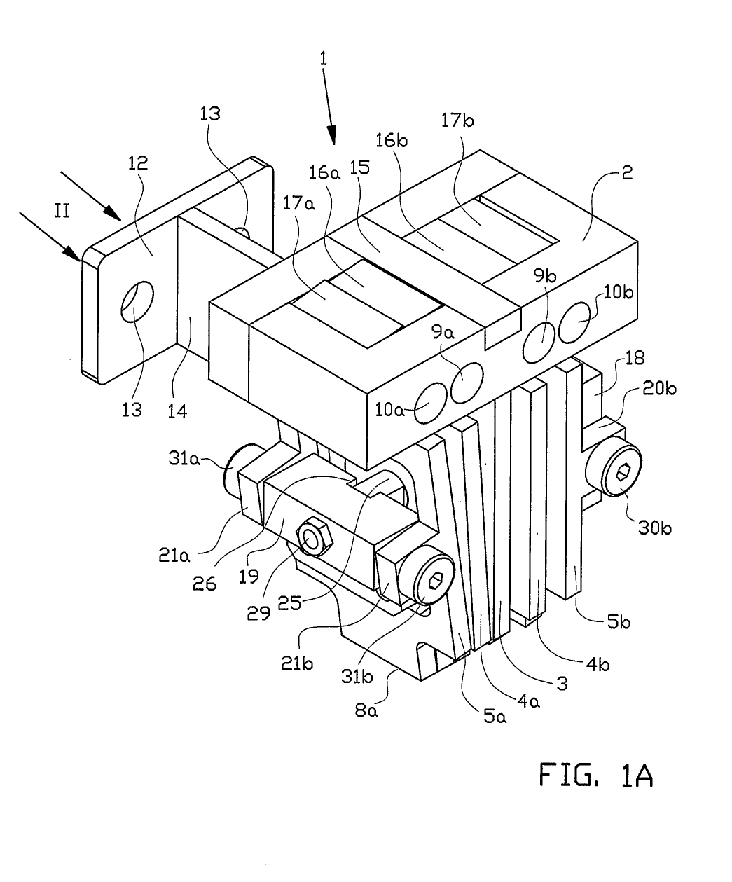

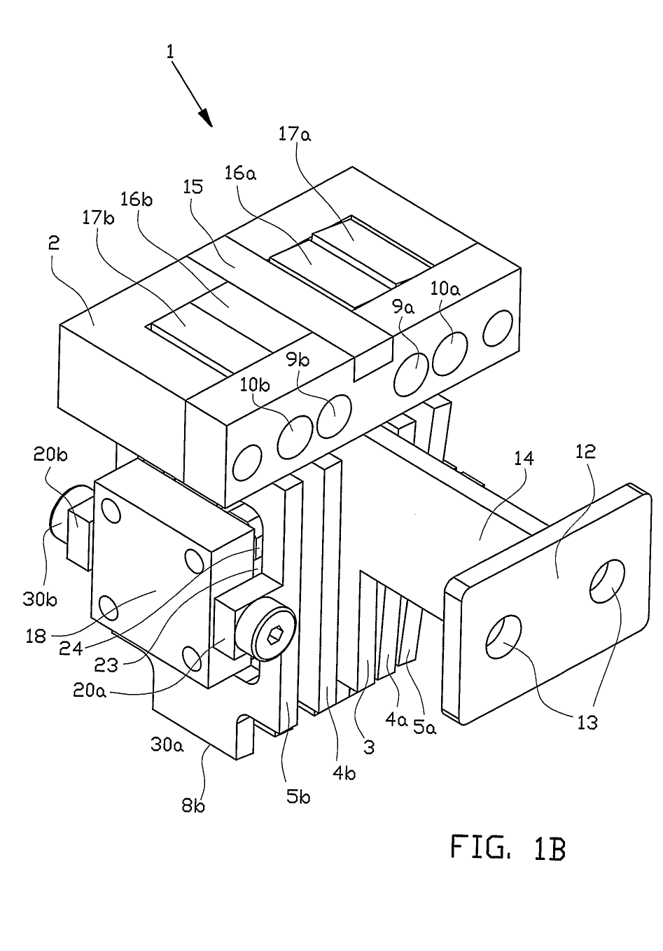

The cylinders 24/piston rod 25 are designed such that the clamping plates 5a,b can be urged towards each other to such an extent that the clamping plates 4a,b are taken along until they abut the end 6 of the fixed clamping plate 3. (In FIGS. 1A and 1B this is illustrated for the clamping plates 4a and 5a, in which it should be noted that in reality the clamping plates 4b and 5b will also be rotated, so that the position of FIG. 4B is achieved.)

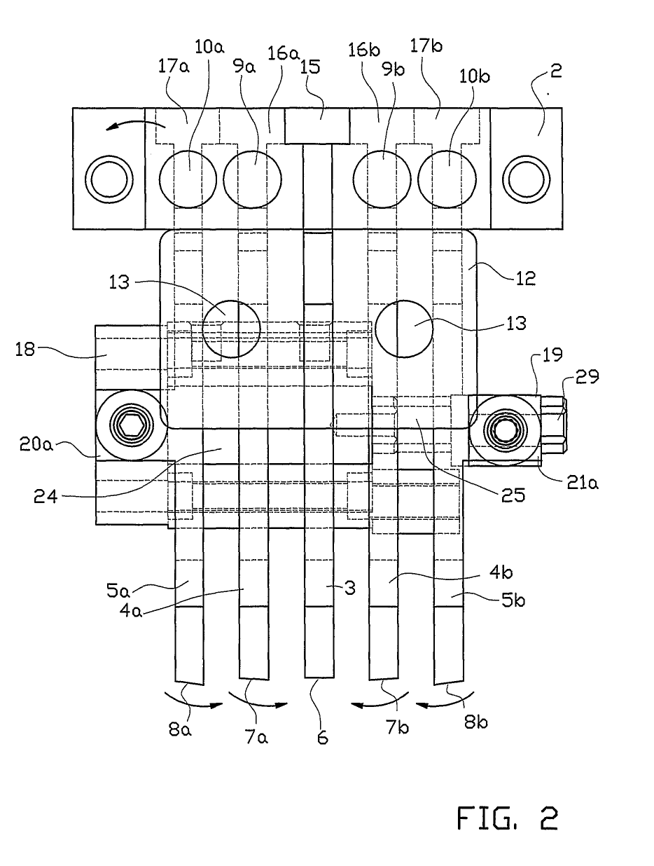

The clamping plates 4a,b and 5a,b here rotate about their pivot pins 16a,b and 17a,b, respectively, possibly due to the play with which the cylinder 25 is accommodated in the holes 23. Due to the design of the T-shaped ends 16a,b and 17a,b, particularly their adjacent surfaces, as well as closing strip 15, it is ensured when the clamping plates 5a,b are rotated back, that the clamping plates 4a,b are urged to the open initial position (FIG. 2), in which the clamping plates 3, 4a,b and 5a,b are parallel one to the other and between them define openings 40 of several millimetres.

In the condition of FIG. 2 the clamping set 1 is moved in the direction A (FIG. 4A) to the object to be conveyed, in this case a jute bag 100. The bag 100 may be part of a stack of bags that is oriented vertically, horizontally or otherwise, which bags have to be taken off one by one and conveyed to a next treatment station, for instance a filling station. The clamping set is pushed against the free surface of the bag, during which the stack may be slightly pressed in. This takes place until the clamping set 1, at least displacement means for it, is subjected to a pre-set resistance.

As can be seen in FIG. 4A the outer surface 101a of the wall 101 of the bag is provided with protruding parts of material, in case of a jute bag of jute fibres 102. They extend into the openings 40 between the clamping plates 3, 4a,b and 5a,b.

Subsequently, retaining the relative position of the clamping set 1 with respect to the bag 100 (and the stack), the cylinder 24 is operated in order to retract the piston rod 25. As a result the clamping plates 4a,b and 5a,b and the pivot pins 9a,b and 10a,b rotate in the direction C (FIG. 4A), wherein their ends 7a,b and 8a,b are moved in the direction D in the direction of end 6 of the clamping plate 3. Finally the ends 6 and 7a, 6 and 7b, 7a and 8a, and 7b and 8b form clamps in between which protruding fibres 102 are clamped fixed. The clamping set 1 has then engaged the outer surface 101a of the wall 1010 of the bag 100. A returning motion in the direction E of the clamping set 1 results in pulling the bag 100 along while removing said bag 100 from the stack. The clamping set 1 is able to transfer the said bag 100 to the next treatment station without problems. There the cylinder 24 is operated to switch the piston rod 25 off again, while forming the openings 40 again. The bag 100 is then separated from the clamping set 1, and the clamping set 1 is able to carry out a new cycle.

In FIG. 2 it can be seen that the ends 7a,b and 8a,b are bevelled off, with a relatively protruding tip at the inside of the clamping plates in question. It can also be seen that said tips extend in plate direction beyond the end 6 of the fixed clamping plate 3. As a result during the closing motion an accommodation of the parts of material that protrude from the wall in between the ends of the adjacent clamping plates moving towards each other is enhanced.

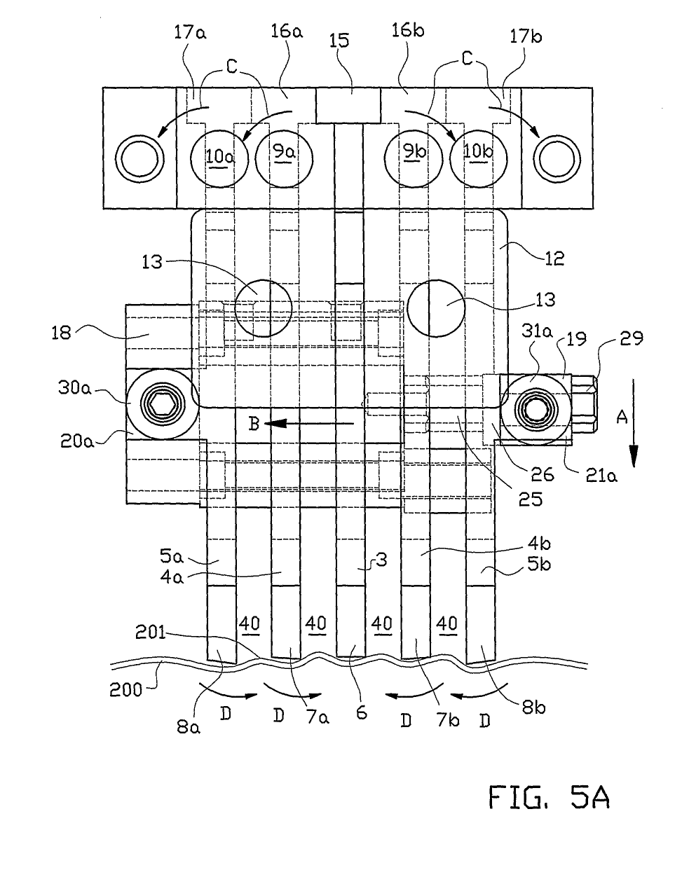

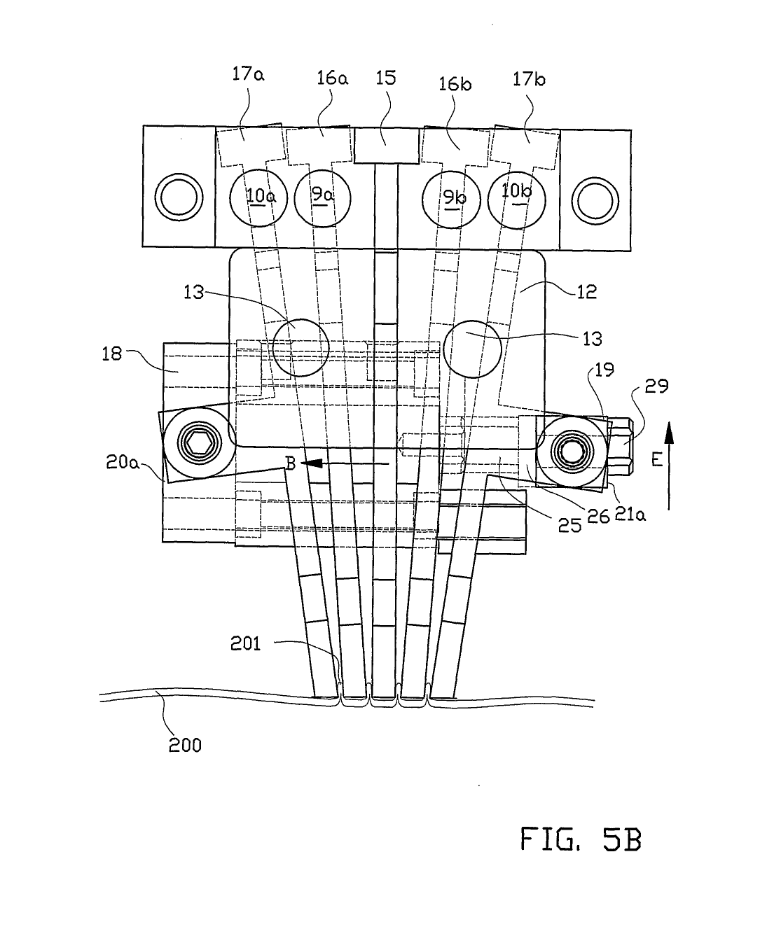

In the example of FIGS. 5A and 5B the bag wall 200 is not provided with protruding fibres. As a result of pressing in the wall 200 the wall sections 201 will enter the spaces 40. Said sections 201 are clamped in between during closing the clamping plates, see FIG. 5B.

Both forms of clamping may coincide: in case of a jute bag such pleats may optionally also be formed within the clamps.

By using the clamping set according to the invention, and the process according to the invention, the outside of an object, particularly a bag, is engaged in a clamping manner, in another way than by clamping either side of for instance the wall of a bag. Parts of material that protrude to the outside out of the plane of the wall of the object in question are clamped in particular, in order to move the object in question. In case of making a pleat during pressing and closing the clamp, this can be compared with clamping a piece of skin of one's own body between two fingers. In case of clamping parts of material that already protrude this can be compared with pulling hairs on the skin. The device according to the invention may for instance be used in moving bags provided with holes for wicket pegs, which bags are supported with said holes on supporting bars, and for instance can be moved along those bars.

The above description is included to illustrate the operation of preferred embodiments of the invention and not to limit the scope of the invention. Starting from the above explanation many variations that fall within the spirit and scope of the present invention will be evident to an expert.

1. Device for conveying objects having a deformable outer surface, particularly a bag, comprising at least one clamping set having at least one clamp, and a displacer for pressing the clamp in an opened position thereof against the surface and an operator for subsequently thereto bringing the clamp from the opened position to a closed position in which at least a part of said surface is clamped.

2. Device according to claim 1 wherein the clamping set comprises several clamps.

3. Device according to claim 2, wherein at least two clamps of the clamping set are situated adjacent to each other and have one clamping jaw in common.

4. Device according to claim 3, wherein three or more clamps of the clamping set are situated adjacent to each other and each time have one clamping jaw in common.

5. Device according to claim 4, wherein the operator for bringing the clamps to the closed position substantially simultaneously acts on the clamps of a clamping set.

6. Device according to claim 3, wherein the common clamping jaw moves when closing the clamps.

7. Device according to claim 3, wherein the common clamping jaw is stationary when closing the clamps.

8. Device according to claim 5, wherein the operator for bringing the clamps to the closed position comprises a common cylinder set.

9. Device according to claim 1, wherein the operator for bringing the clamps to the closed position is adapted for rotating at least one of the clamping jaws in question.

10. Device according to claim 9, wherein the rotatable clamping jaws have spaced apart axes of rotation.

11. Device for conveying objects having a surface made of cloth provided with parts of material that protrude therefrom, for instance a bag having a wall that is at least partially made of textile, comprising at least one clamping set having at least one clamp, and a displaces for pressing the clamp in an opened position thereof against the surface and an operator for subsequently thereto bringing the clamp from the opened position to a closed position in which at least a part of said surface of the cloth is clamped.

12. Device according to claim 11, wherein the clamping set comprises several clamps.

13. Device according to claim 12, wherein at least two clamps of the clamping sets are situated adjacent to each other and have one clamping jaw in common.

14. Device according to claim 13, wherein three or more clamps of the clamping set are situated adjacent to each other and each time have one clamping jaw in common.

15. Device according to claim 14, wherein the operator for bringing the clamps to the closed position substantially simultaneously acts on the clamps of a clamping set.

16. Device according to claim 13, wherein the common clamping jaw moves when closing the clamps.

17. Device according to claim 13, wherein the common clamping jaw is stationary when closing the clamps.

18. Device according to claim 15, wherein the operator for bringing the clamps to the closed position comprises a common cylinder set.

19. Device according to claim 11 wherein the operator for bringing the clamps to the closed position is adapted for rotating at least one of the clamping jaws in question.

20. Device according to claim 19, wherein the rotatable clamping jaws have spaced apart axes of rotation.

21. Method for conveying an object having a wall having an outer surface, wherein the wall is at least partially made of cloth material, which at the outer surface is provided with parts of material that protrude, such as fibres, wherein a device is used comprising at least one clamping set having at least one clamp, and a displacer for pressing the clamp in an opened position thereof against the surface and an operator for subsequently thereto bringing the clamp from the opened position to a closed position in which at least a part of said surface of the cloth is clamped, wherein in the method at least one clamping set having at least one clamp, in the opened position thereof, is pressed against the outer surface and subsequently thereto the clamp is brought into a closed position while clamping the protruding parts of the cloth material of the wall, and the clamping set is moved to a location of discharge, where the clamp is opened again.

22. Method according to claim 21, wherein the cloth surface is jute.

23. Method according to claim 21, wherein the object is a bag having a wall that is at least partially made of textile.
